(19) United States
(12) Patent Application Publication
(10) Pub. No.: US 2004/0181518 A1
(43) Pub. Date: Sep. 16, 2004

(54) System and method for an OLAP engine having dynamic disaggregation

(76) Inventors: Bryan Edward Mayo, Austin, TX (US); Glenn M. Sutton, Austin, TX (US); Charles A. Canning, Austin, TX (US)

Correspondence Address: WILSON SONSINI GOODRICH & ROSATI, 650 PAGE MILL ROAD, PALO ALTO, CA, 943041050

(21) Appl. No.: 10/390,249

(22) Filed: Mar. 14, 2003

(51) Int. Cl. G06F 7/00

(52) U.S. Cl. 707/3

(57) ABSTRACT

In accordance with the present invention, a system and method for an OLAP engine having dynamic disaggregation is provided. A software engine for accessing data in a database includes a graph generator. The graph generator is operable to traverse a hierarchy of nodes of data. The graph generator generates an equation such that the equation relates a first piece of data stored in a first node to a second piece of data of a second node. The software engine further includes a query engine. The query engine is operable to couple to the database. The query engine receives a request for access to the second piece of data. The query engine creates the second piece of data from the first piece of data and the equation.

### BACKGROUND OF THE INVENTION

OnLine Analytical Processing (OLAP) Decision support software is software that allows a user to analyze information that has been stored in various types of databases. OLAP tools can summarize the data into multidimensional views and hierarchies for subsequent use by a user. For example, OLAP tools are used to perform trend analysis, demand planning analysis, supply chain management analysis, and other business analysis on stored data.

Conventional OLAP products include multidimensional OLAP (MOLAP), and relational OLAP (ROLAP). MOLAP tools can extract the date from the multidimensional database and ROLAP tools extract data from traditional relational databases by using statements (for example SQL statements) against relational database tables. Conventional OLAP tools can then place the data from the database into an in-memory cube structure that can be rotated by the user. Alternatively, conventional OLAP tools may not use such an in-memory structure, making it necessary to access the attached database at query time. For the purposes of the remainder of this specification, OLAP is used generically to refer to all types of OLAP products.

The data stored in databases to be accessed by OLAP tools can have a hierarchical structure. For example, some data may be related to other data in a parent-child relationship, sibling relationship, or other type of hierarchical relationship. Each point in the hierarchy can be called a “node.” The function of an OLAP tool to “raise” all such data to the highest node is called “aggregation”, while “pushing” data down to its lowest level node is called “disaggregation.” For illustrative purposes, consider the situation of sales data, broken out in a single dimension of geography. Assume the highest level node of the heirarchy is “United States.” Further assume that the data is broken out by state, and then by county. In such a simple hierarchy, the lowest level nodes are the counties, while the highest level node of the hierarchy is the United States.

Conventional OLAP products have disadvantages. For example, conventional OLAP products force all data down to the lowest level of a data hierarchy when storing new information into a database. For example, if data is entered by a user at a “parent level”, conventional OLAP products disaggregate the entered data and store it in the database at the lowest child level. For example, referring the example above, a conventional OLAP product would force a user that modifies the data at the “United States” node to update in the data included at each county node. This structure, in turn, leads to a data explosion problem as the complexity of the parent-child relationships increase, and as the number of dimensions in the structure increase. Conventional OLAP systems are thus constrained by the size of the database necessary to support such data. Increased size also increases the amount of time needed to query the databases through the OLAP tools.

### BRIEF SUMMARY OF THE INVENTION

In accordance with the present invention, a system and method for an OLAP engine having dynamic disaggregation is provided. A software engine for accessing data in a database includes a graph generator. The graph generator is operable to traverse a hierarchy of nodes of data. The graph generator generates an equation such that the equation relates a first piece of data stored in a first node to a second piece of data of a second node. The software engine further includes a query engine. The query engine is operable to couple to the database. The query engine receives a request for access to the second piece of data. The query engine creates the second piece of data from the first piece of data and the equation.

The method for managing data includes reading a hierarchy of nodes of data. An equation is created from the hierarchy, wherein such equation relates a first node of data stored in a database to a second node of data. The equation is stored. A request for the second piece of data is stored. The first piece of data and the equation are retrieved. The second piece of data is created from the first piece of data and the equation.

It is a technical advantage of the present invention that it can dynamically aggregate and disaggregate data from a database at the time of query.

It is a further technical advantage of the present invention that it eliminates the need to disaggregate entered data to the lowest level before storing such data in an attached database. This in turn can lead to smaller databases.

It is another technical advantage of the present invention that it can allow for additional dimensions in the hierarchy of data. For example, a date-effective hierarchy can be established, letting a user modify input data and track changes over time.

### BRIEF DESCRIPTION OF THE FIGURES

A more complete understanding of the present invention and advantages thereof may be acquired by referring to the following description taken in conjunction with the accompanying drawings in which like reference numbers indicate like features and wherein:

FIG. 1 is a block diagram of an OLAP engine according to one embodiment of the present invention;

FIGS. 2-A, 2-B, and 2-C are flow diagrams of the conversion from an hierarchy into mathematical equations according to one embodiment of the present invention;

FIG. 3 is a flow chart of a method of operation of an OLAP engine according to one embodiment of the present invention; and

FIG. 4 is a block diagram of a computer system including OLAP engine according to one embodiment of the present invention.

### DETAILED DESCRIPTION OF THE INVENTION

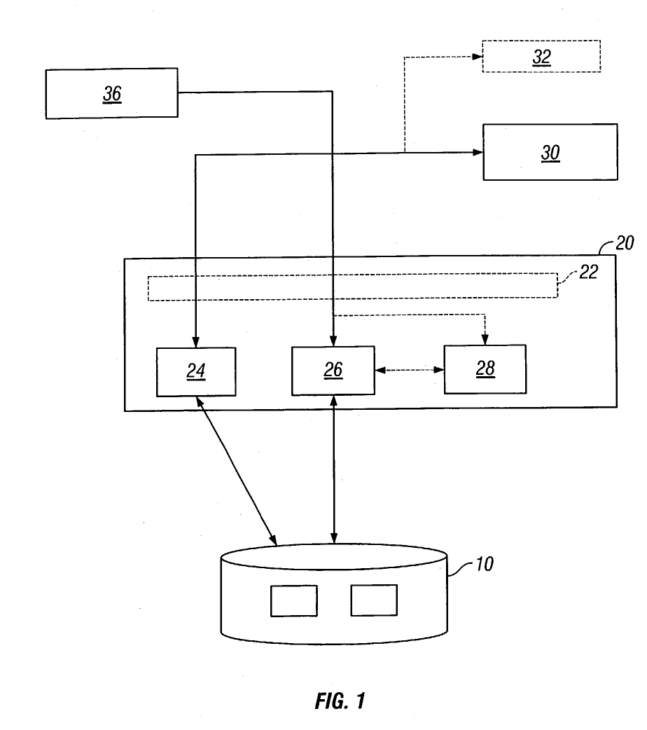

FIG. 1 is a block diagram of an OLAP engine according to one embodiment of the present invention. OLAP engine includes generally a software engine 20. Software engine 20 can comprise for example software operating on a computing device such as a server, personal computer, or any other computing device. Software engine 20 is coupled to database 10. Database 10 can comprise for example a multidimensional database, relational database, or other data structure. Software engine 20 is further coupled to application 36, configurator 30, and alternatively flat file 32. Application 36 and configurator 30 can include software executing on the same or different computing platform as software engine 20. Application 36 and configurator 30 can further include an interface for direct input by users.

Software engine 20 includes graph generator 24 and query engine 26. Alternative embodiments of software engine 20, discussed below, include an application interface 22 coupled to query engine 26 and formula engine 28 coupled to query engine 26 and application interface 22.

Database 10 includes fact table 12 and dimension table 14. Fact table 12 includes the data stored by database 10. Dimension table 14 includes data about the data in fact table 12, otherwise known as “meta” data.

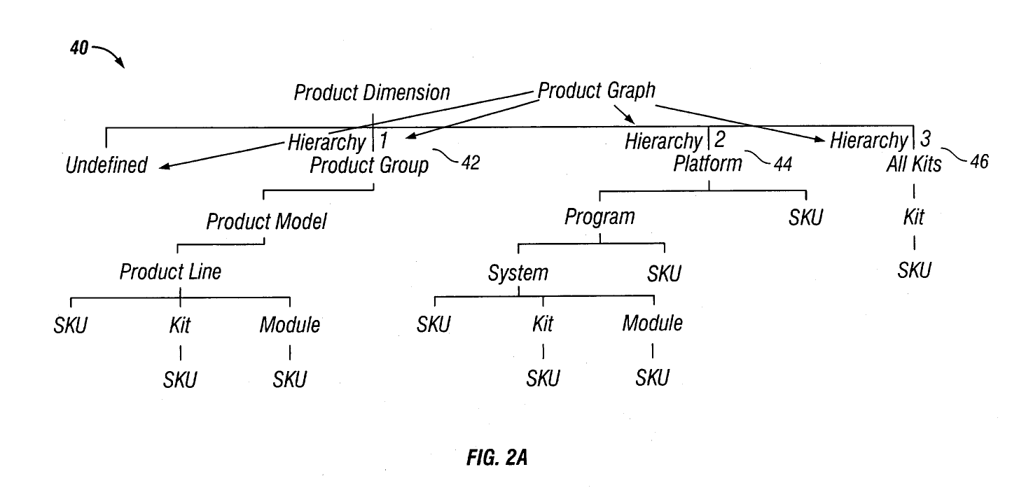

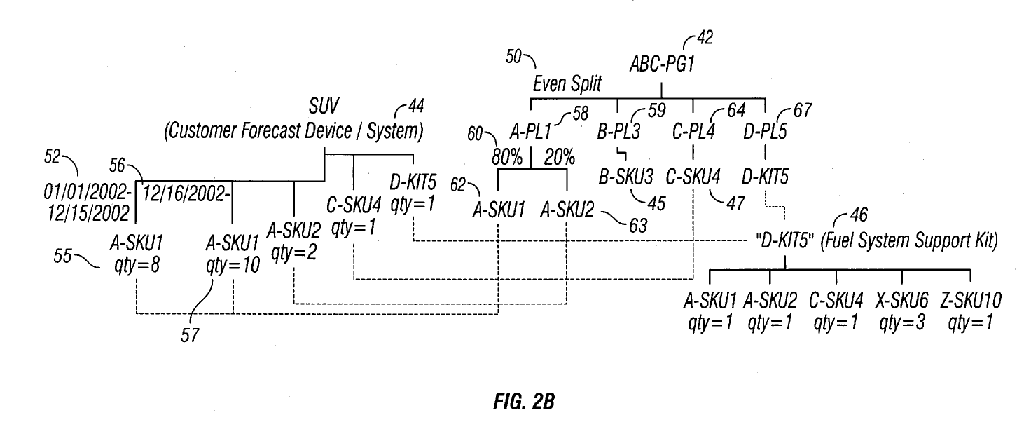

Data stored in fact table 12 can be data related to a hierarchical structure. That is, individual elements of the data in fact table 12 can be related to other elements of data through parent-child, sibling, and further hierarchical relationships. Furthermore, the data in fact 12 can have multiple dimensions. One example of such data having multiple hierarchies and multiple dimensions is described with respect to FIGS. 2A-2C.

In operation, software engine 20 can receive requests for data from database 10, dynamically aggregate and disaggregate the data through its hierarchical structure as necessary at the time of query, and then allow the data to be used by application 36. The operation of software engine 20 to dynamically aggregate and disaggregate data can provide substantial advantages over conventional OLAP engines.

Graph generator 24 is coupled to configurator 30 or alternatively to flat file 32. Configurator 30 allows a user to input a template of the user's business hierarchy for the data. For example, the data may include sales data grouped by product, region, or other variables. Configurator 30 can allow a user to input multiple hierarchies of the data in multiple dimensions. Alternatively, flat file 32 can include such templates that can be input into graph generator 24.

Further in operation, graph generator 24 traverses the hierarchy to generate a mathematical relationship between each node in the hierarchy. From these mathematical relationships, graph generator 24 creates equations such that each node in the hierarchy can be derived from other nodes. For example, such equations can be linear equations as will be discussed with respect to FIGS. 2-A through 2-C. After generating the equations, graph generator stores such equations in dimension table 14. Alternatively, graph generator 24 can store such equations in the memory of the computing platform upon which software engine 20 is operating.

Query engine 26 is coupled to application 36. Application 36 can include, for example, demand planning system, supply chain management system, financial planning system, or other type of software tool that uses data stored in database 10. Query engine 26 can receive a request for data from application 36. Query engine 26 then accesses database 10 and dimension table 14 and fact table 12. For example, in one embodiment, query engine 26 can write SQL statements to access dimension table 14 and fact table 12. Through such access, query engine 26 can retrieve requested data from fact table 12 and also can through using equations stored in dimension table 14 dynamically aggregate and disaggregate data up or down the hierarchy of the data by deriving if necessary each node of the hierarchy.

Query engine 26 can further receive a request from application 36 to store an update to the data in database 10. Because software engine 20 through use of the equations generated by graph generator 24 can aggregate or disaggregate data, it is not necessary for data to be disaggregated to its lowest node in the hierarchy before storage in database 10. As such, the database 10 coupled to software engine 20 can be smaller in size than databases used for the same purpose with conventional OLAP engines.

This increased efficiency can lead to further advantages of the present invention. For example, software engine 20 can allow the storage of data into database 10 in a “date-effective” manner. That is, data can be stored in database 10 in a manner that allows for values at the same node to be different for different periods of time.

An alternative embodiment of software engine 20 includes application interface 22 and formula engine 28. Application interface 22 can operate as an interface to application 36 and can process requests for data from application 36. Formula engine 28 can further perform OLAP type functions such as period to period comparisons, plan versus plan comparisons, and can further override dimensional settings. For example, if application 36 makes a complicated request for data from database 10, application interface 22 can route this request to formula engine 28. Formula engine 28 can then make multiple requests of query engine 26 which can in turn make multiple requests of database 10. Information is then gathered from fact table 12 as well as dynamically using the equations in dimension table 14 in order to compile the requested data. Formula engine 28 and application interface 22 can then format the data such that application 36 can display the data to a user.

FIGS. 2-A, 2-B, and 2-C are flow diagrams of the conversion from an hierarchy into mathematical equations according to one embodiment of the present invention. FIG. 2A is a diagram of a template, shown generally at 40, of a hierarchy of data. For example, template 40 could be input by a user through configurator 30 of FIG. 1. Template 40 is an example of how data could be arranged in a single dimension. The dimension of template 40 is a product dimension. Template 40 includes multiple hierarchies, 42, 44 and 46. Hierarchies 42, 44, and 46 represent, for example, product groupings used within a company as well as how the products are grouped for major customers in sales channels. In the example of FIG. 2-A, hierarchy 42 represents a product group hierarchy, hierarchy 44 represents a platform hierarchy, and hierarchy 46 represents a kit hierarchy.

FIG. 2-B is a specific example of a product hierarchy contained within template 40 of FIG. 2-A. Product group hierarchy “ABC-PG1” 42 includes four sub-product nodes 58, 59, 61 and 63. As indicated at 50, the values of sub-product nodes 58, 59, 61 and 63 are split evenly between the sub-product nodes. Sub-product node 58 further includes two lower nodes 62 and 63. In the example of FIG. 2-B, such lower nodes 62 and 63 can represent individual product SKU numbers. As indicated at 60, the values of lower nodes 62, 63 have an 80% 20% split respectively, in comparison to the value of sub product node 58. In the example of FIG. 2-B, sub product node 59 includes a lower node 45, sub product node 61 includes lower node 47, and sub product node 63 includes kit hierarchy 46.

The links of FIG. 2-B further show that the lower nodes of product group hierarchy 42 are linked to platform hierarchy 44 and kit hierarchy 46. In the embodiment of FIG. 2-B, the links between the nodes as well as business rules tied to the links can be date effective so that they can change over a specified time being analyzed. For example, the link between lower node 62 from platform hierarchy 44 as linked to platform hierarchy 44 can be date effective as shown at 52 and 56. For example, as shown in FIG. 2-B, from Jan. 1, 2002 until Dec. 15, 2002, the quantity of A-SKU1 equals 8, while from Dec. 16, 2002 onward the quantity of A-SKU 1 equals 10.

In operation, the quantities 50 and 60 specify the relationships between nodes in the hierarchies. For example, if a quantity is specified for sub product node 58, that quantity can be disaggregated down according to the specified percentages 60 into a quantity of lower nodes 62 and 63.

FIG. 2-C is a graph of a portion of the hierarchy of FIG. 2-B of product node 42. As shown in the hierarchy of FIG. 2-B, in FIG. 2-C product node 42 is coupled to sub product node 58. As further shown, a weighting factor 50 between product node 42 and sub product node 58 is 0.25. Sub-node 58 is further divided into lower nodes 62 and 63. As shown, the weighting factor 60 between sub product node 58 and lower node 62 is 0.8. Further shown at FIG. 2-C, are the date effective quantities of the nodes connected to lower node 62. As shown in FIG. 2-C, there are three nodes connected to lower node 62: lower nodes 53, 55, and 57. As can be seen from FIG. 2-B, these three lower nodes are descended from the kit hierarchy 46 and plartorm hierarchy 44.

The software engine of the present invention interprets graphs such as FIG. 2-C, including the weighting factors 50 and 60 to creates linear equations in order to be able to dynamically aggregate and disaggregate requested data. The software engine can then use these sets of linear equations to calculate the entry for each node in the hierarchy based on the values at the other nodes within the graph. In the embodiment of FIG. 2-C, such equations are date effective, meaning they can be stored for a relevant time period. For example, the equations for the graph of FIG. 2-C can be:

Jan. 1, 2002-Dec. 15, 2002:

Total Qty(A-SKU1)=[qty(A-SKU1)]+[(0.25)*(0.8)]*[qty(ABC-PG1)]+[(0.8)]*[Qty(A-P11)]+1*[Qty(D-Kit5)]+8*[Qty(SUV)]

Dec. 16, 2002:

Total Qty(A-SKU1)=[qty(A-SKU1)]+[(0.25)*(0.8)]*[qty(ABC-PG1)]+[(0.8)]*[Qty(A-P11)]+1*[Qty(D-Kit5)]+10*[Qty(SUV)]

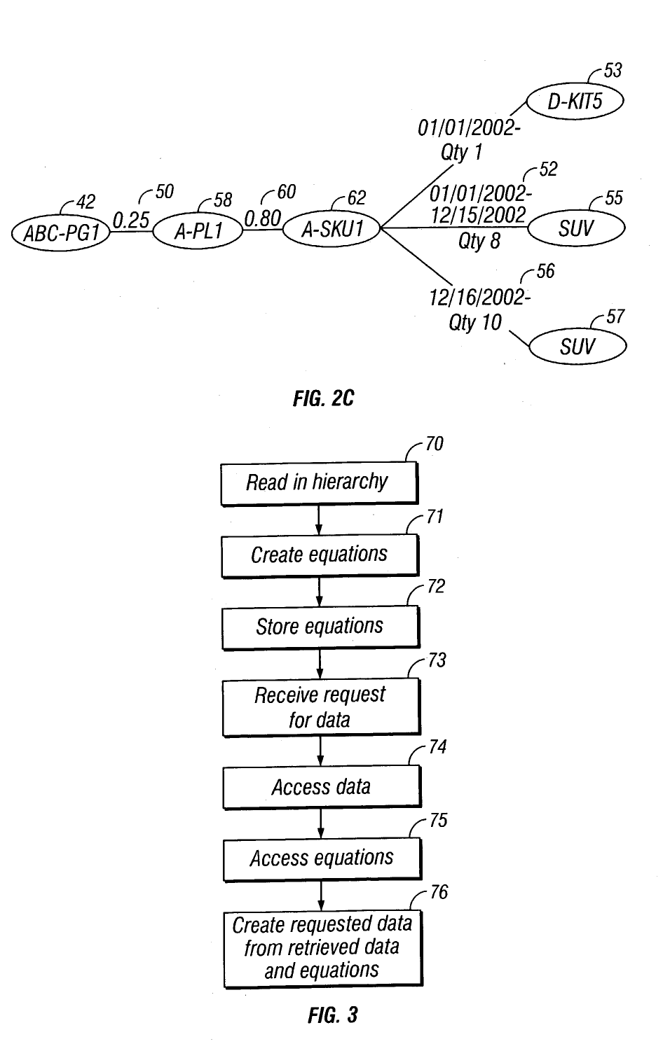

FIG. 3 is a flow chart of a method of operation of an OLAP engine according to one embodiment of the present invention. At step 70, the hierarchy of data is read in. As discussed before, such a hierarchy can be input by a user or is can be read in by the present invention through a flat file or other means of communicating the business relationship of data. At step 71, the hierarchy is traversed and equations are created that mathematically map each node in the hierarchy. For example, as discussed with respect to FIGS. 2-A through 2-C, such equations can be linear equations. At step 72, the equations are stored. For example, such equations can be stored in memory on the platform on which the invention is operating, or the equations can be stored in a database as a dimension file or meta data.

At step 73, a request is received for the data. For example, such a request could comprise a request to compare product plans, a request to make some demand planning, or other type of business plan using the data. At step 74 and 75 the data and the equations created at step 71 are accessed. For example, if the equations are stored in a database, SQL statements can be written to access the equations and data. At step 76 the data that was requested in step 73 is retrieved from the stored data as well as created from the equations created in step 71. By accessing the data and the equations, the present invention can thus dynamically aggregate and disaggregate each node on the hierarchy.

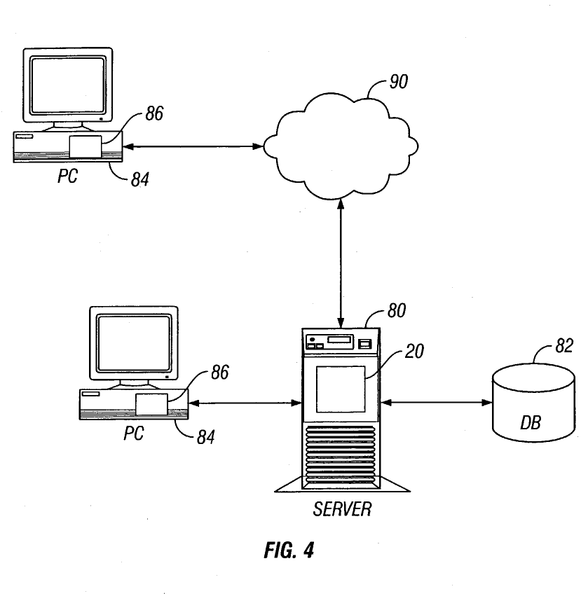

FIG. 4 is a block diagram of a computer system including OLAP engine according to one embodiment of the present invention. Server 80 is a computing platform that includes a computing device on which software engine 20 is stored and executes. Server 80 is coupled to database 82. Database 82 can include for example relational database, multidimensional database or other database structure. Database 82 includes the business data upon which a user wishes to maintain and access. Server 80 is further coupled to PCs 84 and 85. Server 80 can couple to PC 85 through for example a network 90. Network 90 can include a wide area network, local area network, internet, or other communication network. Server 80 is coupled to PC 84 for example by direct connection such as an Ethernet connection. PC 84 includes client 88 and PC 85 includes client 86. Clients 88 and 86 can include for example a browser or other interface operable to interface to software engine 20.

In operation, users interface to PCs 84 and 85 that communicate with software engine 20 on server 80. Users through such devices can create a hierarchy (for example through the configurator of FIG. 1). Users can further communicate requests for data from database 82. Software engine 20 as discussed with respect to the previous figures, can traverse the hierarchy and create mathematical equations that relate each node in the hierarchy of data. Software engine 20 further stores such equations in memory of server 80 or in database 82. Further in operation, if a user through PC 84 or 85 makes a request from database 82, software engine 20 can access data stored in database 82 as well as equations stored in memory of server 80 or database 82 and can dynamically aggregate and disaggregate each node of the hierarchy such that the requested data can be displayed to users of PCs 84 and 85.

Although the present invention has been described in detail, it should be understood that various changes, substitutions, and alterations can be made hereto without departing from the spirit and scope of the invention as defined by the appended claims.

What is claimed is:

1. A software engine for accessing data in a database, the software engine comprising:
a graph generator operable to traverse a hierarchy of nodes of data and generate an equation, wherein such equation relates a first piece of data stored in a first node to a second piece of data of a second node; and
a query engine operable to couple to the database, the query engine operable to receive a request for access to the second piece of data, and create the second piece of data from the first piece of data and the equation.

2. The software engine of claim 1 wherein the hierarchy comprises a plurality of hierarchies representing a plurality of dimensions.

3. The software engine of claim 2 wherein one of the dimensions represents time.

4. The software engine of claim 3 wherein the equation comprises a first equation relating to a first time period and a second equation relating to a second time period.

5. The software engine of claim 1 wherein the graph generator is further operable to receive the hierarchy from a flat file.

6. The software engine of claim 1 wherein the graph generator is further operable to receive the hierarchy from a configurator coupled to the graph generator.

7. The software engine of claim 1 wherein the equation comprises a linear equation.

8. The software engine of claim 1 wherein the graph generator is further operable to store the equation in the database, and wherein the query engine is operable to access the equation through the database.

9. The software engine of claim 8 wherein the query engine accesses the equation through SQL statements.

11. The software engine of claim 1 further comprising a formula engine coupled to the query engine, the formula engine operable to receive a request for data, the formula engine further operable to instruct the query engine to perform a plurality of queries in order to provide the data.

12. The software engine of claim 1, wherein the equation comprises a plurality of equations such that each node in the hierarchy can be derived.

13. A computer readable medium, the computer readable medium including instructions that when executed create a software engine comprising:
a graph generator operable to traverse a hierarchy of nodes of data and generate an equation, wherein such equation relates a first piece of data stored in a first node to a second piece of data of a second node; and
a query engine operable to couple to the database, the query engine operable to receive a request for access to the second piece of data, and create the second piece of data from the first piece of data and the equation.

14. The computer readable medium of claim 13 wherein the hierarchy comprises a plurality of hierarchies representing a plurality of dimensions.

15. The computer readable medium of claim 14 wherein one of the dimensions represents time.

16. The computer readable medium of claim 15 wherein the equation comprises a first equation relating to a first time period and a second equation relating to a second time period.

17. The computer readable medium of claim 13 wherein the equation comprises a linear equation.

18. The computer readable medium of claim 13 wherein the query engine accesses the equation through SQL statements.

19. The computer readable medium of claim 13, wherein the equation comprises a plurality of equations such that each node in the hierarchy can be derived.

20. A computer system for accessing data in a database comprising:
a computing platform coupled to a database;
a graph generator executing on the computing platform, the graph generator operable to traverse a hierarchy of nodes of data and generate an equation, wherein such equation relates a first piece of data stored in a first node to a second piece of data of a second node; and
a query engine executing on the computing platform, the query engine operable to couple to the database, the query engine operable to receive a request for access to the second piece of data, and create the second piece of data from the first piece of data and the equation.

21. The computer system of claim 20 wherein the hierarchy comprises a plurality of hierarchies representing a plurality of dimensions.

22. The computer system of claim 21 wherein one of the dimensions represents time.

23. The computer system of claim 22 wherein the equation comprises a first equation relating to a first time period and a second equation relating to a second time period.

24. The computer system of claim 20 wherein the equation comprises a linear equation.

25. The computer readable medium of claim 20, wherein the equation comprises a plurality of equations such that each node in the hierarchy can be derived.

26. A method for managing data, the method comprising:
reading a hierarchy of nodes of data;
creating an equation from the hierarchy, wherein such equation relates a first node of data stored in a database to a second node of data;
storing the equation;
receiving a request for the second piece of data;
retrieving the first piece of data;
retrieving the equation; and
creating the second piece of data from the first piece of data and the equation.

27. The method of claim 26 wherein the step of reading a hierarchy comprises reading a plurality of hierarchies representing a plurality of dimensions.

28. The method of claim 26 wherein the step of reading a hierarchy comprises to receive the hierarchy from a flat file.

29. The method of claim 26 wherein the step of creating equations comprises creating linear equations.

30. The method of claim 26 wherein the storing step comprises storing the equation in the database.

31. The method of claim 26 wherein the step of retrieving the equation comprises writing a SQL statement to retrieve the equation.
